(19) United States
(12) Patent Application Publication
(10) Pub. No.: US 2025/0081134 A1
(43) Pub. Date: Mar. 6, 2025

(54) TIME DIFFERENCE DETERMINATION METHOD, ELECTRONIC DEVICE, AND STORAGE MEDIUM

(71) Applicant: ZTE CORPORATION, Shenzhen (CN)

(72) Inventors: Feng BI, Shenzhen (CN); Youxiong LU, Shenzhen (CN); Weimin XING, Shenzhen (CN); Ting MIAO, Shenzhen (CN); Jie CHEN, Shenzhen (CN)

(21) Appl. No.: 18/727,247

(22) PCT Filed: Jan. 3, 2023
(86) PCT No.: PCT/CN2023/070120

§ 371 Date: Jul. 8, 2024

(30) Foreign Application Priority Data
Jan. 7, 2022 (CN) 202210015652.7

(51) Int. Cl. H04W 56/00; H04W 88/08

(52) U.S. Cl. CPC H04W 56/0045; H04W 56/0015; H04W 88/08

(57) ABSTRACT

Provided are a time difference determination method, an electronic device, and a storage medium. The time difference determination method includes determining a time difference according to at least one of a first-type parameter or a second-type parameter. The first-type parameter include at least one of a timing advance N_{TA} or a first timing advance offset N_{TA,offset}. The second-type parameter include at least one of a timing parameter index T_{delta}, a timing parameter reference N_{delta}, or a timing parameter granularity Gₛₜₑₚ.

### TECHNICAL FIELD

The present application relates to the field of radio communication technology, for example, a time difference determination method, an electronic device, and a storage medium.

### BACKGROUND

With the continuous advancement of radio technology, various radio services are flourishing. However, frequency spectrum resources on which the radio services are relied are limited. In the face of the increasing demand for bandwidth, these spectrum resources ranging from 300 MHz to 3 GHz, which the conventional commercial communication primarily adopted, are in extreme shortage and cannot satisfy the requirements of radio wireless communication. In new-generation wireless communication systems such as a new radio (NR) system or a 5th-generation mobile communication (5G) system, a carrier frequency such as 28 GHz, 45 GHz or 70 GHz higher than that in the 4th-generation mobile communication (4G) system is adopted for communication. Such a high-frequency channel has the defects of having a larger free-propagation loss, being easily absorbed by oxygen and being greatly affected by rain attenuation, thus seriously affecting the coverage performance of a high-frequency communication system. However, a carrier frequency corresponding to such high-frequency communication has a shorter wavelength, ensuring that more antenna elements can be accommodated per unit area. The arrangement of more antenna elements means that the beamforming method can be used to increase antenna gains, ensuring the coverage performance of high-frequency communication.

As a dense cell has been increasingly becoming an important application scenario, the dense cell requires more network deployment cost. However, the introduction of wireless backhaul transmission can make the network deployment easier and greatly reduce the network deployment cost. In addition, since the NR system includes the high-frequency band, the physical characteristics of the high-frequency carrier determine the coverage range of the NR system. This fact brings about a huge challenge, but wireless backhaul transmission can also solve this problem. Based on the above requirements, projects have been initiated for integrated access and backhaul (IAB) in the NR system. For ease of description, a link between a node and a parent-node is referred to as a backhaul link (BL). A link between a node and a child-node or a link between the node and a user equipment (UE) is referred to as an access link (AL). The parent-node may be a donor node (DN), and the DN may include a donor gNB. Meanwhile, in order to overcome the problem of transmitting-receiving self-interference caused by half-duplex relay nodes in in-band scenarios, the following multiplexing manners between BL and AL are proposed: time division multiplexing (TDM), spatial division multiplexing (SDM), and frequency division multiplexing (FDM). In the manner of TDM, different time resources are used between BL and AL. In the manner of SDM, different beam resources are used between BL and AL. In the manner of FDM, different frequency resources are used between BL and AL. In current standards, two functions are specified for a relay node (RN), an IAB mobile terminal (IAB-MT) and an IAB distribution unit (IAM-DU). The IAB-MT communicates with an upstream node. The IAB-DU communicates with a downstream node (including a downstream terminal). The system requires an alignment of downlink transmitting timing between various nodes to implement network synchronization and reduce the mutual interference between the nodes. In principle, as long as the IAB-node advances, based on the DRT of the IAB-MT, by half of the timing advance (TA), the downlink transmitting (Tx) timing (DTT) of the IAB-DU is determined, and thus, the DTT alignment between the nodes can be maintained. However, due to reasons such as an implementation at the upstream node, an offset exists between the uplink receiving (Rx) timing (URT) of the upstream node and the DTT of the upstream node. Therefore, the IAB-node cannot simply consider that the DTT obtained by the IAM-MT advancing, based on DRT, by TA/2 is the actual DTT of the IAB-DU. To solve this problem, a timing parameter T_delta is introduced in the system. That is, the IAB-node may advance based on the DRT of the IAB-MT by a time difference TD, where TD=TA/2+T_delta. That is, the time difference TD may be used for determining the DTT (DTT=DRT-TD) of the node, thereby maintaining the DTT alignment between the nodes. However, it is not clear how to determine the time difference between the DTT of the parent-DU and the DRT of the IAB-MT in different timing manners.

### SUMMARY

Embodiments of the present application is to provide a time difference determination method, an electronic device, and a storage medium.

The time difference determination method provided by the embodiments of the present application includes the following.

A time difference is determined according to at least one of a first-type parameter or a second-type parameter. The first-type parameter include at least one of a timing advance N_{TA} or a first timing advance offset N_{TA,offset}. The second-type parameter include at least one of a timing parameter index T_{delta}, a timing parameter reference N_{delta}, or a timing parameter granularity Gₛₜₑₚ.

The electronic device provided by the embodiments of the present application includes one or more processors and a memory in which one or more programs are stored.

When executed by the one or more processors, the one or more programs cause the one or more processors to perform the time difference determination method provided in any embodiment of the present application.

The computer-readable storage medium provided by the embodiments of the present application includes one or more programs, where when the one or more programs are executed by one or more processors, the time difference determination method provided in any embodiment of the present application is performed.

### BRIEF DESCRIPTION OF DRAWINGS

FIG. 1 is a schematic diagram of a timing mode according to an embodiment of the present application.

FIG. 2 is a schematic diagram of another timing mode according to an embodiment of the present application.

FIG. 3 is a schematic diagram of another timing mode according to an embodiment of the present application.

FIG. 4 is a schematic diagram of another timing mode according to an embodiment of the present application.

FIG. 5 is a flowchart of a time difference determination method according to an embodiment of the present application.

FIG. 6 is another flowchart of the time difference determination method according to an embodiment of the present application.

FIG. 7 is another flowchart of the time difference determination method according to an embodiment of the present application.

FIG. 8 is a structural diagram of a time difference determination apparatus according to an embodiment of the present application.

FIG. 9 is a structural diagram of an electronic device according to an embodiment of the present application.

### DETAILED DESCRIPTION

Suffixes such as “module”, “component” or “unit” used for indicating elements in the subsequent description are used merely for facilitating the description of the present application, and have no particular meaning in themselves. Therefore, “module”, “component” or “unit” may be used in a mixed manner.

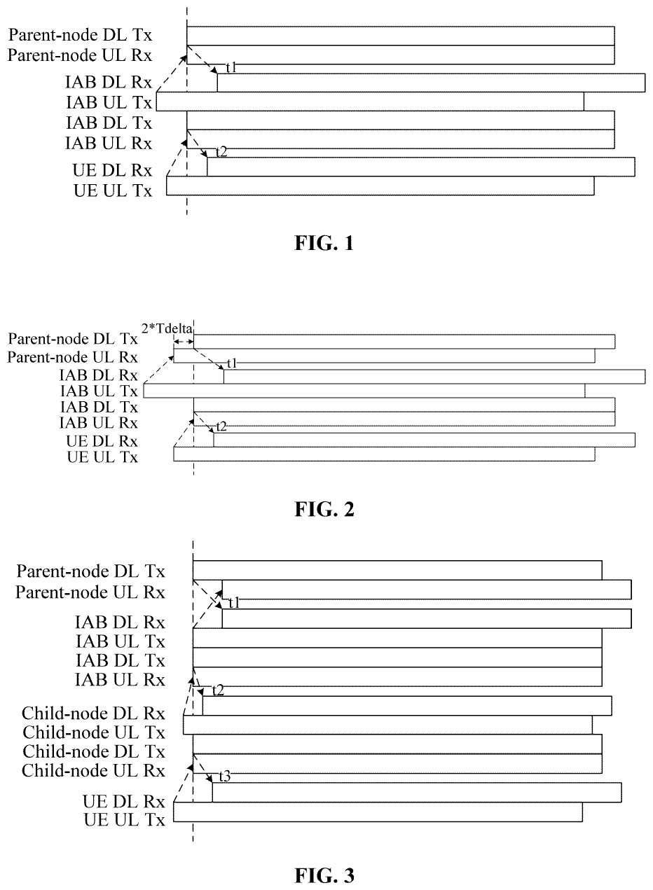

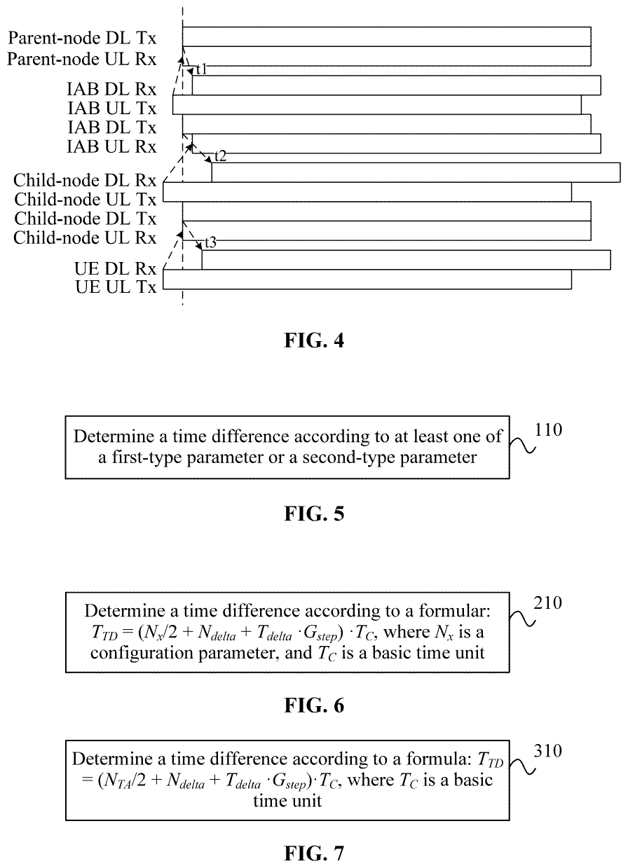

In the present application, an upstream node of an IAB-node is referred to as a parent-node of the IAB-node. The parent-node may also be considered as a serving cell for the IAB-node. A downstream node of the IAB-node may be referred to as a child-node or a UE. The IAB-node may be considered as a serving cell for the child-node or the UE. That is, from the perspective of the relative relationship between nodes, the IAB-node may also be considered as a child-node of the parent-node of the IAB-node, and as a parent-node of the child-node of the IAB-node. The IAB-node is defined with two functions, one of which is an IAB-MT and the other of which is an IAB-DU. The IAB-MT communicates with the upstream node. The IAB-DU communicates with the downstream node. The downstream node may include a terminal. Additionally, the present application provides three main timing modes including: (1) a first timing mode or a non-simultaneous transmission mode, (2) a second timing mode or a simultaneous transmission mode, and (3) a third timing mode or a co-reception mode. In the first timing mode, the downstream transmitting timing of a node is aligned with the downstream transmitting timing of a parent node or a serving node of this node; and the first timing mode can be referred to FIGS. 1 and 2. In the second timing mode, the uplink transmitting timing of a node is aligned with the downlink transmitting timing of this node, or, the downlink transmitting timing of this node is aligned with the downlink transmitting timing of a parent-node or a serving node of this node, and the second timing mode can be referred to FIG. 3. In the third timing mode, the uplink receiving timing of a node is aligned with the downlink receiving timing of this node, or, the downlink transmitting timing of the node is aligned with the downlink receiving timing of a parent-node or a serving node of this node, and the third timing mode can be referred to FIG. 4.

The preceding three timing modes is described from the perspective of the UL Tx timing (UTT) of the IAB-MT as below.

In the first timing mode, the UTT of the IAB-MT is determined by (N_{TA}+N_{TA,offset})·T_{C}.

In the second timing mode, the UTT of the IAB-MT is aligned with or set as the downlink Tx timing (DTT) of the IAB-DU.

In the third timing mode, the UTT of the IAB-MT is determined by (N_{TA}+N_{TA,offset})·T_{C}, (N_{TA}+N_{TA,offset}+N_{TA,add_offset})·T_{C}, or, (N_{TA}+N_{TA,offset}−N_{TA,add_offset})·T_{C}.

Additionally, relevant terms used in the present application are introduced herein.
N_{TA} denotes a timing advance, and refers to a timing advance of the UTT of the IAB-MT with respect to the DRT of the IAB-MT.
N_{TA,offset} denotes a timing advance offset and includes 0·T_{C}, 13792·T_{C}, 25600·T_{C}, or 39936·T_{C}.
T_{C} denotes a basic time unit, where T_{C}=1/(Δfₘₐₓ·N_{f}), Δfₘₐₓ=480.10³ Hz, and N_{f}=4096.
Δf denotes a sub-carrier spacing.
μ denotes a sub-carrier spacing index, where Δf=2^{μ}·15 kHz.
T_{delta} denotes a timing parameter index.
N_{delta} denotes a timing parameter reference.
Gₛₜₑₚ denotes a timing parameter granularity or denotes the step size of each timing parameter adjustment.

FIG. 5 is a flowchart of a time difference determination method according to an embodiment of the present application. This embodiment of the present application may be applied to cases of different timing modes, and in the cases, the time difference between the DTT of a parent-DU and the DRT of an IAB-MT is determined, and relevant parameters in a time difference formulas are determined. Referring to FIG. 5, this embodiment of the present application specifically includes the operation 110 below.

In operation 110, a time difference is determined according to at least one of a first-type parameter or a second-type parameter. The first-type parameter include at least one of a timing advance N_{TA}, a first timing advance offset N_{TA,offset}, or a second timing advance offset N_{TA,add_offset}. The second-type parameter include at least one of a timing parameter index T_{delta}, a timing parameter reference N_{delta}, or a timing parameter granularity Gₛₜₑₚ.

The first-type parameter may be parameters for indicating the time duration of a timing advance. The first-type parameter may include the timing advance, the first timing advance offset, and the second timing advance offset. The first timing advance offset may be a preset time offset. The second timing advance offset may be a time offset configured by a parent-node or a serving node. The second-type parameter may indicate the time granularity of the timing advance and may include the timing parameter index, the timing parameter reference, and the timing parameter granularity.

In this embodiment of the present application, the time difference may be determined according to at least one of the first-type parameter or the second-type parameter. The time difference may be used for time alignment.

Further, based on the preceding embodiments of the present application, determining the time difference according to at least one of the first-type parameter or the second-type parameter includes the following.

The time difference is determined according to the formular:

$${T}_{TD} = ( ( {N}_{TA} + {N}_{TA , add \_ offset} ) / 2 + {N}_{delta} + {T}_{delta} \cdot {G}_{step} ) \cdot {T}_{C} , or ,$$

according to the formular:

$${T}_{TD} = ( ( {N}_{TA} - {N}_{TA , add \_ offset} ) / 2 + {N}_{delta} + {T}_{delta} \cdot {G}_{step} ) \cdot {T}_{C} ,$$

where T_{C} is a basic time unit.

In this embodiment of the present application, the time difference may be determined through the preceding formula according to at least one of the first-type parameter or the second-type parameter in any timing mode.

Further, based on the preceding embodiments of the present application, in a first timing mode, the timing advance N_{TA} included in the first-type parameter is a timing advance of the uplink transmitting timing of the IAB-MT with respect to the downlink receiving timing of the IAB-MT and is configured by the parent-node or the serving node, where N_{TA,add_offset}=0.

In this embodiment of the present application, the timing advance N_{TA} included in the first-type parameter may be the timing advance of the uplink transmitting timing of the IAB-MT with respect to the downlink receiving timing of the IAB-MT and may be configured by the parent-node or serving node of the IAB-node.

Further, based on the preceding embodiments of the present application, in a second timing mode, the timing advance included in the first-type parameter satisfies that N_{TA}=T_{TA}/T_{C} or that N_{TA}=T_{TA}/T_{C}−N_{TA,offset}. T_{TA} is a time interval between the uplink transmitting timing of the IAB-MT and the downlink receiving timing of the IAB-MT. N_{TA,add_offset}=0.

The timing advance included in the first-type parameter may be set as the value of T_{TA}/T_{C} or the value of T_{TA}/T_{C}−N_{TA,add_offset}. T_{TA} may denote the time interval between the uplink transmitting timing of the IAB-MT and the downlink receiving timing of the IAB-MT. In the second timing mode, N_{TA,add_offset} may be set to 0.

Further, based on the preceding embodiments of the present application, in the third timing mode, the timing advance N_{TA} included in the first-type parameter is the timing advance of the uplink transmitting timing of the IAB-MT with respect to the downlink receiving timing of the IAB-MT and is configured by the parent-node or the serving node, and the second timing advance offset N_{TA,add_offset} included in the first-type parameter is configured by the parent-node or the serving node.

In the embodiments of the present application, the timing advance used for determining the time difference may be the timing advance of the uplink transmitting timing of the IAB-MT configured by the parent-node or the serving node with respect to the downlink receiving timing of the IAB-MT, and the value of the second timing advance offset may be configured by the parent-node or the serving node.

In an embodiment, the time difference T_{TD} is determined based on one of the formulas below:

$${T}_{TD} = ( ( {N}_{TA} + {N}_{TA , add \_ offset} ) / 2 + {N}_{delta} + {T}_{delta} \cdot {G}_{step} ) \cdot {T}_{C} ; or ,$$

$${T}_{TD} = ( ( {N}_{TA} - {N}_{TA , add \_ offset} ) / 2 + {N}_{delta} + {T}_{delta} \cdot {G}_{step} ) \cdot {T}_{C} .$$

In the first timing mode, N_{TA} is the timing advance of the UTT of the IAB-MT configured by the parent-node (parent) with respect to the DRT of the IAB-MT, and N_{TA,add_offset}=0.

In the second timing mode, N_{TA}=T_{TA}/T_{C}, or, N_{TA}=T_{TA}/T_{C}−N_{TA,offset}. T_{TA} is the time interval between the UTT of the IAB-MT and the DRT of the IAB-MT. N_{TA,offset} is a timing advance offset, and N_{TA,add_offset}=0. The time interval may be measured and obtained by the IAB-node. The unit (or dimension) of the time interval may be a direct time unit (dimension) with the basic time unit T_{C} as a granularity or an indirect time unit (dimension) with a natural number as a granularity. That is, the direct time unit divided by the basic time unit T_{C} represents the indirect time unit, for example, 0·T_{C}, 13792·T_{C}, 25600·T_{C}, or, 39936·T_{C}.

In the third timing mode, N_{TA} is the timing advance of the UTT of the IAB-MT configured by the parent-node (parent) with respect to the DRT of the IAB-MT, and N_{TA,add_offset} is a parameter configured by the parent-node (parent) and used for adjusting the UTT of the IAB-MT in the third timing mode.

FIG. 6 is another flowchart of the time difference determination method according to an embodiment of the present application. This embodiment of the present application provides details based on the preceding embodiments of the present application. Referring to FIG. 6, the time difference determination method provided in this embodiment of the present application includes the following operation 210.

In the operation 210, the time difference is determined according to the formular: T_{TD}=(Nₓ/2+N_{delta}+T_{delta}−Gₛₜₑₚ)·T_{C}, where Nₓ is a configuration parameter, and T_{C} is the basic time unit.

In the embodiments of the present application, the timing difference may be determined through the timing parameter index T_{delta}, the timing parameter reference N_{delta}, and the timing parameter granularity Gₛₜₑₚ. Nₓ is the parameter configured by the IAB-node. The value of Nₓ may be determined according to the first-type parameter or set according to service needs.

Further, based on the preceding embodiments of the present application, in the first timing mode, the configuration parameter Nₓ satisfies that Nₓ=N_{TA}, where N_{TA} is the timing advance of the uplink transmitting timing of the IAB-MT configured by the parent-node or the serving node with respect to the downlink receiving timing of the IAB-MT.

The value of the configuration parameter may be set to the timing advance in the first-type parameter. The timing advance may be the value of the timing advance of the uplink transmitting timing of the IAB-MT configured by the parent-node or serving node of the IAB-node with respect to the downlink receiving timing of the IAB-MT.

Further, based on the preceding embodiments of the present application, in the second timing mode, the configuration parameter Nₓ satisfies that Nₓ=T_{TA}/T_{C} or that Nₓ=T_{TA}/T_{C}−N_{TA,offset}, where T_{TA} is the time interval between the uplink transmitting timing of the IAB-MT and the downlink receiving timing of the IAB-MT.

In this embodiment of the present application, in the second timing mode, the value of the configuration parameter used for determining the time difference may be determined according to the first timing offset N_{TA,offset} and the time interval between the UTT of the IAB-MT and the DRT of the IAB-MT. The configuration parameter may be set to the value of T_{TA}/T_{C} or the value of T_{TA}/T_{C}−N_{TA,add_offset}.

Further, based on the preceding embodiments of the present application, in the third timing mode, the configuration parameter Nₓ satisfies that Nₓ=N_{TA}+N_{TA,add_offset} or that Nₓ=N_{TA}-N_{TA,add_offset}. N_{TA} is the timing advance of the uplink transmitting timing of the IAB-MT configured by the parent-node or the serving node with respect to the downlink receiving timing of the IAB-MT, and the second timing advance offset N_{TA,add_offset} included in the first-type parameter is configured by the parent-node or the serving node.

In the third timing mode, the configuration parameter used for determining the time difference may be the timing advance of the UTT of the IAB-MT with respect to the DRT of the IAB-MT, and the time advance is configured by the parent-node (parent) of the IAB-node, where N_{TA,add_offset} is determined according to a parameter configured by the parent-node.

In an embodiment, the time difference T_{TD} may be determined in any timing mode according to the following formula:

$${T}_{TD} = ( {N}_{x} / 2 + {N}_{delta} + {T}_{delta} \cdot {G}_{step} ) \cdot {T}_{C} .$$

In the first timing mode, Nₓ=N_{TA}, where N_{TA} is the timing advance of the UTT of the IAB-MT configured by the parent-node (parent) with respect to the DRT of the IAB-MT.

In the second timing mode, Nₓ=T_{TA}/T_{C} or Nₓ=T_{TA}/T_{C}−N_{TA,offset}. T_{TA} is the time interval between the UTT of the IAB-MT and the DRT of the IAB-MT. N_{TA,offset} is the timing advance offset. The time interval may be measured and obtained by the IAB-node. The unit (or dimension) of the time interval may be a direct time unit (dimension) with the basic time unit T_{C} as a granularity or an indirect time unit (dimension) with a natural number as a granularity. That is, the direct time unit divided by the basic time unit T_{C} represents the indirect time unit, for example, 0·T_{C}, 13792·T_{C}, 25600·T_{C}, or 39936·T_{C}.

In the third timing mode, Nₓ=N_{TA}+N_{TA,add_offset} or Nₓ=N_{TA}−N_{TA,add_offset}. N_{TA} is the timing advance of the UTT of the IAB-MT with respect to the DRT of the IAB-MT and the time advance herein is configured by the parent-node, and N_{TA,add_offset} is a parameter configured by the parent-node and used for adjusting the UTT of the IAB-MT in the third timing mode.

FIG. 7 is another flowchart of the time difference determination method according to an embodiment of the present application. This embodiment of the present application is the refinement based on the preceding embodiments of the present application. Referring to FIG. 7, the time difference determination method provided in this embodiment of the present application includes the following operation 310.

In the operation 310, the time difference is determined according to the formular:

$${T}_{TD} = ( {N}_{x} / 2 + {N}_{delta} + {T}_{delta} \cdot {G}_{step} ) \cdot {T}_{C} ,$$

Where T_{C} is the basic time unit. In this embodiment of the present application, the time difference T_{TD} may be determined according to all of the timing advance N_{TA}, the timing parameter index T_{delta}, the timing parameter reference N_{delta}, and the timing parameter granularity Gₛₜₑₚ. In any timing mode, the IAB-node may use the timing advance, the timing parameter reference, the timing parameter granularity and the relationship according to the preceding formula to determine the time difference.

Further, based on the preceding embodiments of the present application, in the first timing mode, the timing advance N_{TA} included in the first-type parameter is the timing advance of the uplink transmitting timing of the IAB-MT with respect to the downlink receiving timing of the IAB-MT, and the timing advance herein is configured by the parent node or the serving node.

In the embodiments of the present application, in the case of determining the time difference in the first timing mode, the timing advance N_{TA} may be the timing advance of the uplink transmitting timing of the IAB-MT with respect to the downlink receiving timing of the IAB-MT, and configured by the parent node or the serving node.

Further, based on the preceding embodiments of the present application, in the second timing mode, the first-type parameter includes the time advance N_{TA}=T_{TA}/T_{C} or N_{TA}=T_{TA}/T_{C}-N_{TA,offset}, where T_{TA} is the time interval between the uplink transmitting timing of the IAB-MT and the downlink receiving timing of the IAB-MT.

In the case where the IAB-node determines the time difference in the second timing mode, the time difference may be determined based on that N_{TA}=T_{TA}/T_{C} or that N_{TA}=T_{TA}/T_{C}-N_{TA,offset}. The value of T_{TA} may be the time interval between the uplink transmitting timing of the IAB-MT and the downlink receiving timing of the IAB-MT.

Further, based on the preceding embodiments of the present application, in the third timing mode, the value of N_{TA} is replaced with N_{TA}+N_{TA,add_offset} or N_{TA}−N_{TA,add_offset}, where N_{TA} is the timing advance of the uplink transmitting timing of the IAB-MT with respect to the downlink receiving timing of the IAB-MT, configured by the parent-node or the serving node, and the second timing advance offset N_{TA,add_offset} included in the first-type parameter is configured by the parent-node or the serving node.

In the embodiments of the present application, in the case where the IAB-node determines the time difference in the third timing mode, N_{TA} in the preceding formula for determining the time difference may be replaced with N_{TA}+N_{TA,add_offset} or N_{TA}−N_{TA,add_offset}, where N_{TA} is the timing advance of the uplink transmitting timing of the IAB-MT with respect to the downlink receiving timing of the IAB-MT configured by the parent-node or the serving node, and the second timing advance offset N_{TA,add_offset} may be configured by the parent-node or serving node of the IAB-node.

Further, based on the preceding embodiments of the present application, in the third timing mode, the timing advance N_{TA} included in the first-type parameter is the timing advance of the uplink transmitting timing of the IAB-MT with respect to the downlink receiving timing of the IAB-MT configured by the parent node or the serving node.

In an embodiment, by way of example, the IAB-node determines the time difference in the second timing mode according to T_{TD}=(N_{TA}/2+N_{delta}+T_{delta}−Gₛₜₑₚ)·T_{C}, where the timing advance N_{TA} is determined according to the formula below N_{TA}=T_{TA}/T_{C} or N_{TA}=T_{TA}/T_{C}−N_{TA,offset}. T_{TA} is the time interval between the UTT of the IAB-MT and the DRT of the IAB-MT. N_{TA,offset} is the timing advance offset. The time interval may be measured and obtained by the IAB-node. The unit of the time interval may be a direct time unit with the basic time unit T_{C} as a granularity or an indirect time unit with a natural number as a granularity. That is, the direct time unit divided by the basic time unit T_{C} represents the indirect time unit.

In another embodiment, by way of example, the IAB-node determines the time difference in the third timing mode. In the third timing mode, T_{TD}=(N_{TA}/2+N_{delta}+T_{delta}−Gₛₜₑₚ)·T_{C}, where N_{TA} is replaced with N_{TA}+N_{TA,add_offset} or N_{TA}−N_{TA,add_offset}, where N_{TA} is the timing advance of the UTT of the IAB-MT with respect to the DRT of the IAB-MT and configured by the parent-node, and N_{TA,add_offset} is a parameter configured by the parent-node and used for adjusting the uplink transmitting timing of the IAB-MT.

In another embodiment, by way of example, the IAB-node determines the time difference in the third timing mode. In the third timing mode, T_{TD}=(N_{TA}/2+N_{delta}+T_{delta}−Gₛₜₑₚ)·T_{C}, where the timing advance N_{TA} is determined in the following manner: N_{TA} is the timing advance of the UTT of the IAB-MT with respect to the DRT of the IAB-MT and configured by the parent-node (parent) of the IAB-node.

Further, based on the preceding embodiments of the present application, the value of the timing parameter index T_{delta}, the value of the timing parameter reference N_{delta}, and the value of the timing parameter granularity Gₛₜₑₚ may be the same or different in different timing modes.

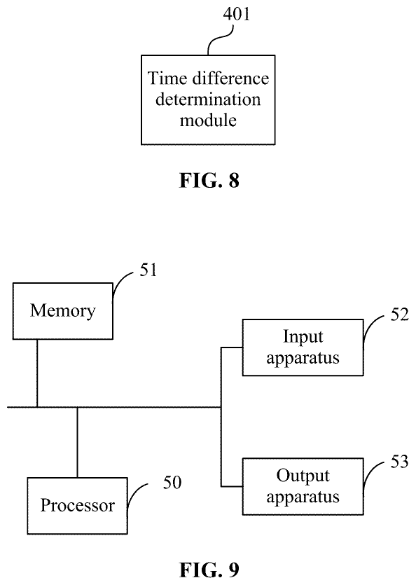

FIG. 8 is a structural diagram of a time difference determination apparatus according to an embodiment of the present application. The apparatus may perform the time difference determination method provided in any embodiment of the present application and has function modules and effects corresponding to the time difference determination method performed. The apparatus may be implemented by software and/or hardware and includes a time difference determination module 401.

The time difference determination module 401 is configured to determine a time difference according to at least one of a first-type parameter or a second-type parameter.

The first-type parameter include at least one of a timing advance N_{TA}, a first timing advance offset N_{TA,offset}, or a second timing advance offset N_{TA,add_offset}.

The second-type parameter include at least one of a timing parameter index T_{delta}, a timing parameter reference N_{delta}, or a timing parameter granularity Gₛₜₑₚ.

In this embodiment of the present application, the time difference is determined by the time difference determination module according to at least one of the first-type parameter or the second-type parameter, implementing the network time synchronization in network systems, reducing the mutual interference between nodes, and maintaining the transmitting timing alignment between different nodes in different network systems.

Further, based on the preceding embodiments of the present application, the time difference determination module 401 includes a first processing unit.

The first processing unit is configured to determine the time difference according to a formula:

$${T}_{TD} = ( ( {N}_{TA} + {N}_{TA , add \_ offset} ) / 2 + {N}_{delta} + {T}_{delta} \cdot {G}_{step} ) \cdot {T}_{C} ,$$

according to a formula:

$${T}_{TD} = ( ( {N}_{TA} - {N}_{TA , add \_ offset} ) / 2 + {N}_{delta} + {T}_{delta} \cdot {G}_{step} ) \cdot {T}_{C} .$$

In the above formulas, T_{C} is a basic time unit.

Further, based on the preceding embodiments of the present application, in the first timing mode, the timing advance N_{TA} included in the first-type parameter is the timing advance of the uplink transmitting timing of the IAB-MT configured by the parent node or the serving node with respect to the downlink receiving timing of the IAB-MT. N_{TA,add_offset}=0.

Further, based on the preceding embodiments of the present application, in the second timing mode, the timing advance N_{TA} included in the first-type parameter satisfies that N_{TA}=T_{TA}/T_{C} or that N_{TA}=T_{TA}/T_{C}−N_{TA,offset}. T_{TA} is the time interval between the uplink transmitting timing of the IAB-MT and the downlink receiving timing of the IAB-MT. N_{TA,add_offset}=0.

Further, based on the preceding embodiments of the present application, in the third timing mode, the timing advance N_{TA} included in the first-type parameter is the timing advance of the uplink transmitting timing of the IAB-MT configured by the parent-node or the serving node with respect to the downlink receiving timing of the IAB-MT, and the second timing advance offset N_{TA,add_offset} included in the first-type parameter is configured by the parent-node or the serving node.

Further, based on the preceding embodiments of the present application, the time difference determination module 401 includes a second processing unit.

The second processing unit is configured to determine the time difference according to a formula:

$${T}_{TD} = ( {N}_{x} / 2 + {N}_{delta} + {T}_{delta} \cdot {G}_{step} ) \cdot {T}_{C} .$$

In the above formula, Nₓ is a configuration parameter, and T_{C} is the basic time unit.

Further, based on the preceding embodiments of the present application, in the first timing mode, the configuration parameter Nₓ satisfies that Nₓ=N_{TA}. N_{TA} is the timing advance of the uplink transmitting timing of the IAB-MT with respect to the downlink receiving timing of the IAB-MT and configured by the parent node or the serving node.

Further, based on the preceding embodiments of the present application, in the second timing mode, the configuration parameter Nₓ satisfies that Nₓ=T_{TA}/T_{C} or that Nₓ=T_{TA}/T_{C}−N_{TA,offset}. T_{TA} is the time interval between the uplink transmitting timing of the IAB-MT and the downlink receiving timing of the IAB-MT.

Further, based on the preceding embodiments of the present application, in the third timing mode, the configuration parameter Nₓ satisfies that Nₓ=N_{TA}+N_{TA,add_offset} or that Nₓ=N_{TA}−N_{TA,add_offset}. N_{TA} is the timing advance of the uplink transmitting timing of the IAB-MT with respect to the downlink receiving timing of the IAB-MT and configured by the parent node or the serving node, and the second timing advance offset N_{TA,add_offset} included in the first-type parameter is configured by the parent node or the serving node.

Further, based on the preceding embodiments of the present application, the time difference determination module 401 includes a third processing unit.

The third processing unit is configured to determine the time difference according to a formula:

$${T}_{TD} = ( {N}_{TA} / 2 + {N}_{delta} + {T}_{delta} \cdot {G}_{step} ) \cdot {T}_{C} .$$

In the above formula, T_{C} is the basic time unit.

Further, based on the preceding embodiments of the present application, in the first timing mode, the timing advance N_{TA} included in the first-type parameter is the timing advance of the uplink transmitting timing of the IAB-MT configured by the parent node or the serving node with respect to the downlink receiving timing of the IAB-MT.

Further, based on the preceding embodiments of the present application, in the second timing mode, the timing advance N_{TA} included in the first-type parameter satisfies that N_{TA}=T_{TA}/T_{C} or that N_{TA}=T_{TA}/T_{C}−N_{TA,offset}. T_{TA} is the time interval between the uplink transmitting timing of the IAB-MT and the downlink receiving timing of the IAB-MT.

Further, based on the preceding embodiments of the present application, in the third timing mode, the value of N_{TA} is replaced with N_{TA}+N_{TA,add_offset} or N_{TA}−N_{TA,add_offset}. N_{TA} is the timing advance of the uplink transmitting timing of the IAB-MT with respect to the downlink receiving timing of the IAB-MT and configured by the parent node or the serving node, and the second timing advance offset N_{TA,add_offset} included in the first-type parameter is configured by the parent node or the serving node.

Further, based on the preceding embodiments of the present application, in the third timing mode, the timing advance N_{TA} included in the first-type parameter is the timing advance of the uplink transmitting timing of the IAB-MT configured by the parent node or the serving node with respect to the downlink receiving timing of the IAB-MT.

FIG. 9 is a structural diagram of an electronic device according to an embodiment of the present application. The electronic device includes a processor 50, a memory 51, an input apparatus 52, and an output apparatus 53. One or more processors 50 may be disposed in the electronic device. One processor 50 is taken as an example in FIG. 9. The processor 50, the memory 51, the input apparatus 52 and the output apparatus 53 in the electronic device may be connected via a bus or in other manners. The connection via a bus is taken as an example in FIG. 9.

The memory 51 is a computer-readable storage medium, and software programs, computer-executable programs, and modules, such as a module (time difference determination module 401) corresponding to the apparatus in embodiments of the present application may be stored in the memory 51. The processor 50 executes software programs, instructions, and modules stored in the memory 51 to perform function applications and data processing of the electronic device, that is, to perform the preceding time difference determination method.

The memory 51 may mainly include a program storage region and a data storage region. The program storage region may store an operating system and an application program required by at least one function. The data storage region may store data created based on the use of the electronic device. Additionally, the memory 51 may include a high-speed random-access memory and may also include a nonvolatile memory, such as at least one magnetic disk memory, a flash memory, or another nonvolatile solid-state memory. In some examples, the memory 51 may further include a memory remotely disposed with respect to the processor 50. These remote memories may be connected to the electronic device via a network. Examples of the preceding network include, but are not limited to, the Internet, an intranet, a local area network, a mobile communication network and a combination thereof.

The input apparatus 52 may be configured to receive inputted digital or character information and generate key signal input related to user settings and function control of the electronic device. The output apparatus 53 may include a display device such as a display screen.

In an embodiment, a time difference determination system is provided. The system includes one or more electronic devices. When performing a program, one or more processors of the one or more electronic devices implements determining a time difference based on a first-type parameter and a second-type parameter.

The first-type parameter include at least one of a timing advance N_{TA}, a first timing advance offset N_{TA,offset}, or a second timing advance offset N_{TA,add_offset}.

The second-type parameter include at least one of a timing parameter index T_{delta}, a timing parameter reference N_{delta}, or a timing parameter granularity Gₛₜₑₚ.

Embodiments of the present application further provide a storage medium including computer-executable instructions. When the computer-executable instructions are executed by a computer processor, a time difference determination method is performed. The time difference determination method includes the following.

A time difference is determined according to at least one of a first-type parameter or a second-type parameter.

The first-type parameter include at least one of a timing advance N_{TA}, a first timing advance offset N_{TA,offset}, or a second timing advance offset N_{TA,add_offset}.

The second-type parameter include at least one of a timing parameter index T_{delta}, a timing parameter reference N_{delta}, or a timing parameter granularity Gₛₜₑₚ.

From the preceding description of embodiments, it is apparent to those skilled in the art that the present application may be implemented by use of software and necessary general-purpose hardware or may be implemented by hardware. Based on this understanding, the technical solutions of the present application substantially, or the part contributing to the related art, may be embodied in the form of a software product. The computer software product may be stored in a computer-readable storage medium such as a floppy disk, a read-only memory (ROM), a random-access memory (RAM), a flash memory, a hard disk, or an optical disk of a computer and includes several instructions for causing a computer device (which may be a personal computer, a server, or a network device) to perform the time difference determination method in the embodiments of the present application.

It is to be noted that units and modules that are included in the embodiment of the apparatus are merely divided according to functional logic, and the division is not limited to this as long as the corresponding functions can be performed. Additionally, the specific names of function units are merely intended for distinguishing between each other and are not to limit the scope of the present application.

It is to be understood by those having ordinary skill in the art that some or all steps of the preceding method and function modules/units in the preceding system or device may be implemented as software, firmware, hardware and suitable combinations thereof.

In the hardware implementation, the division of the preceding function modules/units may not correspond to the division of physical components. For example, one physical component may have multiple functions, or one function or operation may be performed jointly by several physical components. Some or all physical components may be implemented as software executed by a processor such as a central processing unit, a digital signal processor or a microprocessor, may be implemented as hardware, or may be implemented as integrated circuits such as application-specific integrated circuits. Such software may be distributed on computer-readable media. The computer-readable media may include computer storage media (or non-transitory media) and communication media (or transitory media). As is known to those having ordinary skill in the art, the term computer storage media include volatile and nonvolatile media as well as removable and non-removable media implemented in any method or technology for storing information (such as computer-readable instructions, data structures, program modules or other data). The computer storage media include, but are not limited to, a random-access memory (RAM), a read-only memory (ROM), an electrically erasable programmable read-only memory (EEPROM), a flash memory or other memory technologies, a compact disc read-only memory (CD-ROM), a digital versatile disc (DVD) or other optical disc storages, a magnetic cassette, a magnetic tape, a magnetic disk or other magnetic storage devices, or any other medium that can be used for storing desired information and can be accessed by a computer. Additionally, as is known to those having ordinary skill in the art, the communication media generally include computer-readable instructions, data structures, program modules or other data in carriers or in modulated data signals transported in other transport mechanisms and may include any information delivery medium.

1. A time difference determination method, comprising:
determining a time difference according to at least one of a first-type parameter or a second-type parameter,
wherein the first-type parameter comprise at least one of a timing advance N_{TA} or a first timing advance offset N_{TA,offset}; and
the second-type parameter comprise at least one of a timing parameter index T_{delta}, a timing parameter reference N_{delta}, or a timing parameter granularity Gₛₜₑₚ.

2. The time difference determination method according to claim 1, wherein determining the time difference according to at least one of the first-type parameter or the second-type parameter comprises:
determining the time difference according to a formula:
$${T}_{TD} = {T}_{TA} / 2 + ( - {N}_{TA , offset} / 2 + {N}_{delta} + {T}_{delta} \cdot {G}_{step} ) \cdot {T}_{C} ,$$
wherein T_{TA}=N_{TA}·T_{C}, or, T_{TA}=(N_{TA}+N_{TA,offset})·T_{C}, and T_{C} is a basic time unit.

3-6. (canceled)

7. An electronic device, comprising:
one or more processors; and
a memory in which one or more programs are stored,
wherein the one or more programs, when executed by the one or more processors, cause the one or more processors to perform:
determining a time difference according to at least one of a first-type parameter or a second-type parameter,
wherein the first-type parameter comprise at least one of a timing advance N_{TA} or a first timing advance offset N_{TA,offset}; and
the second-type parameter comprise at least one of a timing parameter index T_{delta}, a timing parameter reference N_{delta}, or a timing parameter granularity Gₛₜₑₚ.

8. A non-transitory computer-readable storage medium comprising instructions, wherein the instructions, when executed by one or more processors, implements:
determining a time difference according to at least one of a first-type parameter or a second-type parameter,
wherein the first-type parameter comprise at least one of a timing advance N_{TA} or a first timing advance offset N_{TA,offset}; and
the second-type parameter comprise at least one of a timing parameter index T_{delta}, a timing parameter reference N_{delta}, or a timing parameter granularity Gₛₜₑₚ.

9. The time difference determination method according to claim 2, wherein in a first timing mode, T_{TA} is a timing advance of uplink transmitting timing of an integrated access and backhaul mobile terminal (IAB-MT) with respect to downlink receiving timing of the IAB-MT, and is configured by a parent node or a serving node.

10. The time difference determination method according to claim 9, wherein in the first timing mode, the uplink transmitting timing of the IAB-MT is determined by T_{TA}, wherein T_{TA}=(N_{TA}+N_{TA,offset})·T_{C}.

11. The time difference determination method according to claim 2, wherein in a second timing mode, T_{TA} is a time interval between uplink transmitting timing of an IAB-MT and downlink receiving timing of the IAB-MT.

12. The time difference determination method according to claim 11, wherein in the second timing mode, the uplink transmitting timing of the IAB-MT is set as downlink transmitting timing of the IAB-MT.

13. The time difference determination method according to claim 2, wherein in a third timing mode, T_{TA} is a timing advance of uplink transmitting timing of an IAB-MT with respect to downlink receiving timing of the IAB-MT, and is configured by a parent node or a serving node.

14. The time difference determination method according to claim 13, wherein in the third timing mode, the uplink transmitting timing of the IAB-MT is determined by T_{TA}+N_{TA,add_offset}·T_{C}.

15. The electronic device according to claim 7, wherein determining the time difference according to at least one of the first-type parameter or the second-type parameter comprises:
determining the time difference according to a formula:
$${T}_{TD} = {T}_{TA} / 2 + ( - {N}_{TA , offset} / 2 + {N}_{delta} + {T}_{delta} \cdot {G}_{step} ) \cdot {T}_{C} ,$$
wherein T_{TA}=N_{TA}·T_{C}, or, T_{TA}=(N_{TA}+N_{TA,offset})·T_{C}, and T_{C} is a basic time unit.

16. The electronic device according to claim 15, wherein in a first timing mode, T_{TA} is a timing advance between uplink transmitting timing of an integrated access and backhaul mobile terminal (IAB-MT) and downlink receiving timing of the IAB-MT, and is configured by a parent node or a serving node.

17. The electronic device according to claim 16, wherein in the first timing mode, the uplink transmitting timing of the IAB-MT is determined by T_{TA}, wherein T_{TA}=(N_{TA}+N_{TA,offset})·T_{C}.

18. The electronic device according to claim 15, wherein in a second timing mode, T_{TA} is a time interval between uplink transmitting timing of an IAB-MT and downlink receiving timing of the IAB-MT.

19. The electronic device according to claim 18, wherein in the second timing mode, the uplink transmitting timing of the IAB-MT is set as downlink transmitting timing of the IAB-MT.

20. The non-transitory computer-readable storage medium according to claim 8, wherein determining the time difference according to at least one of the first-type parameter or the second-type parameter comprises:
determining the time difference according to a formula:
$${T}_{TD} = {T}_{TA} / 2 + ( - {N}_{TA , offset} / 2 + {N}_{delta} + {T}_{delta} \cdot {G}_{step} ) \cdot {T}_{C} ,$$
wherein T_{TA}=N_{TA}·T_{C}, or, T_{TA}=(N_{TA}+N_{TA,offset})·T_{C}, and T_{C} is a basic time unit.

21. The non-transitory computer-readable storage medium according to claim 20, wherein in a first timing mode, T_{TA} is a timing advance of uplink transmitting timing of an integrated access and backhaul mobile terminal (IAB-MT) with respect to downlink receiving timing of the IAB-MT, and is configured by a parent node or a serving node.

22. The non-transitory computer-readable storage medium according to claim 21, wherein in the first timing mode, the uplink transmitting timing of the IAB-MT is determined by T_{TA}, wherein T_{TA}=(N_{TA}+N_{TA,offset})·T_{C}.

23. The non-transitory computer-readable storage medium according to claim 20, wherein in a second timing mode, T_{TA} is a time interval between uplink transmitting timing of an IAB-MT and downlink receiving timing of the IAB-MT.

24. The non-transitory computer-readable storage medium according to claim 23, wherein in the second timing mode, the uplink transmitting timing of the IAB-MT is set as downlink transmitting timing of the IAB-MT.
